(19) United States
(12) Patent Application Publication
(10) Pub. No.: US 2018/0000677 A1
(43) Pub. Date: Jan. 4, 2018

(54) DENTIST'S UNIT

(71) Applicant: Heka Dental A/S, Ishøj (DK)

(72) Inventor: Thomas Steen Nielsen, Ishøj (DK)

(21) Appl. No.: 15/542,643

(22) PCT Filed: Jan. 6, 2016
(86) PCT No.: PCT/DK2016/000001

§ 371 Date: Jul. 10, 2017

(30) Foreign Application Priority Data
Jan. 12, 2015 (DK) BA 2015 00003
Jan. 14, 2015 (DK) BA 2015 00005

(51) Int. Cl. A61G 15/14

(52) U.S. Cl. CPC A61G 15/14

(57) ABSTRACT

By supplying a dentist's unit with joint made supports in the shape of arms (5, 7, 13), as carriers of respectively a bracket table (9) and a lamp (16), built in actuators can be programmed for adjustment of the supports. Furthermore, signal transmitters in the shape of light transmitters (17) can be mounted to the underside of the bracket table (9) and the lamp (16) for visual display of desired data for the treatment, in form of the patient's condition or instrumental data for display (19) onto the patient (21).

### PRIOR ART

The invention relates to a dentist's unit comprising supports to which one or more bracket tables and lamps are mounted to a lower part.

Units of this kind are part of conventional equipment at any dental clinic. To ease the work as much as possible for the dentist and his assistant, if any, it is important partly that the bracket table is not obstructing the work, and partly that it is easy to position in regard to the patient.

It is known to use equipment with visual signaling from the instruments/resources that are part of the conventional treatment, which registrations are shown either with the help of a screen or a display.

However, these known markers suffer from the disadvantage that the dentist/surgeon must turn his eyes from the patient to the display in order to keep informed of the data.

Known units of this kind suffer from one or more disadvantages, such as a lack of adequately stable bracket tables, and thereby unstable to position, as well as easy access to information close to the mouth including patient data. Furthermore, the connections to the instruments are often detached making the cleaning difficult, just as the surfaces of the bracket table and the lower part of the unit are difficult to clean.

### THE OBJECT OF THE INVENTION

It is the object of the invention to ensure the best possible support and mobility of the bracket table, so that it is easy to position, as well as to ensure that all surfaces of the equipment are easily kept clean.

This is achieved, according to the invention, when the bracket table/tables is revolvingly embedded to a bracket table arm, which bracket table arm is partly tilt-ably embedded to a bearing arm and partly revolvingly embedded to the bearing arm, which bearing arm is revolvingly embedded to a support, which is built into the lower part.

In this way the bracket table will be easy to move within the desired work area, so that it at all times will be in the best possible position, both during the dentist's treatment and when the patient moves to and from the chair.

Furthermore, the object of the invention is to redress shortages of the visual signal transmission without this causing any other disadvantages or inconveniences, and this is achieved, according to the invention, when one or more light transmitters are mounted to the table and/or the lamp for projection of light signals onto the patient, as described in claim 2.

In this surprisingly simple manner the dentist/doctor, as well as any assistants, who might be standing on either side of the patient, would directly be able to watch the registrations in the form of projected light signals onto the patient, and thereby continuously follow the various connections, instruments, which might be in use during the treatment, as well as the condition of the patient can be monitored.

To be able to continuously watch the various functions and conditions without having to move the eyes from the patient's mouth, offers a considerably more relaxed work situation, to the benefit of the patient, as well as the user.

By mounting the light transmitter to the table's/lamp's underside, the signals can be directly projected onto the patient.

By, as described in claim 3, connecting the signal transmitter with the instruments, such as intensity, speed and settings as well as the supply lines, such as water, air, suction, all these parameters will be visually controllable, in that the signals can be displayed onto a napkin on the patient.

By, as described in the claim, giving signals in the form of markers, such as with color or symbol, the marking could work as color shift, intensity shift, variable extension, as well as auditive signal transmission could be connected, in the case of risky states or conditions, as described in claim 4.

By mounting the lamp revolvingly to an arm, which is embedded to a support, as described in claim 5, the lamp can be turned to the correct position in relation to the object.

By, as described in claim 6, supplying the embeddings with built in actuators, a robot-like mobility will be obtainable and thereby a possibility of predetermining the position of the bracket table.

This makes simplifying the work possible, in that the position of the table can be programmed independently of the treatment in such a way that the instruments are of the best possible accessibility to the dentist.

Finally, it is efficient, as mentioned in claim 7, to supply the bracket table and/or the lower part with a glass surface, in that these are easy to keep clean due to the smooth surface of the glass, and at the same time would be attractive to look at due to the reflection.

### THE DRAWING

The invention will now be explained more fully with reference to the drawing, in which

FIG. 1 shows a side view of a unit where the bracket table is in a user position,

FIG. 2 shows the unit viewed from the front

FIG. 3 shows the unit viewed from above,

FIG. 4 shows a schematic picture of the unit with a patient in a lying position and

FIG. 5 shows the patient and the table seen toward the head of the patient.

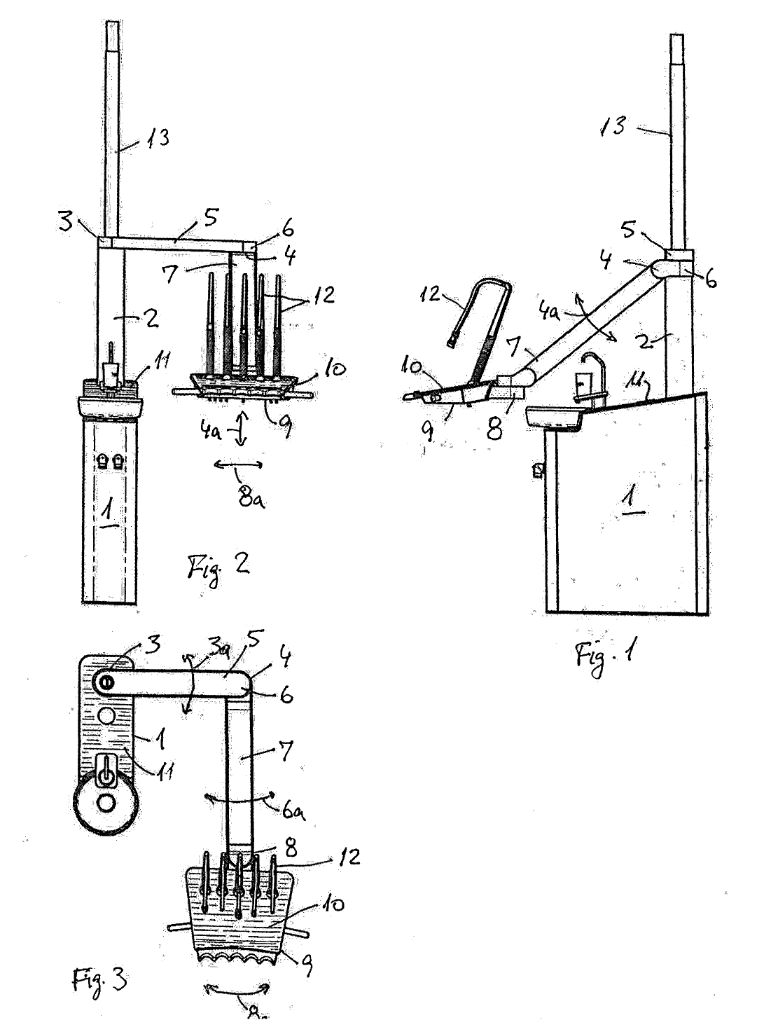

### DESCRIPTION OF THE METHOD

The unit is, according to the invention, as shown in the drawing, in principal a known unit, which has been improved concerning the mobility of the bracket table, visualization of data and securing the best possible hygiene.

The unit entails a lower part 1 that comprises the necessary connections, which lower part's upper side is supplied with a rinsing glass for water and a sink.

To ease the cleaning of this area, the top is equipped with a glass plate 11, which covers the surface and ensures easy cleaning, and thereby the hygiene.

To this lower part 1 is mounted a vertical bearing stand 2, to which the necessary supports of the bracket table 9 and a lamp 16 are mounted.

The support comprises an arm 5, which is suspended to the stand 2 in a bedding 3 so that it, as shown in FIG. 3, is able to swing/turn 3a in relation to the stand 2.

To this arm 5 is embedded 4 an additional arm 7, which partly is able to tilt 4a as shown in FIG. 1, and partly, with the help of a built in bedding 6, can be turned 6a, as shown in FIG. 3.

Finally, with the help of an arm 7, a bracket table 9 is embedded 8, so that the table 9 is able to swing/turn, as shown in FIG. 3.

This arm system ensures complete stabilization of the bracket table 9, concurrent with the fact that it can be brought into every practically necessary position in regard to treatment, entry and accessibility.

The embedding can be equipped with built in actuators, so that all turning- and tilting movements can be programmed, as well as it ensures that the necessary hold of the position will be secured.

To ensure the best hygiene in regard to the table 9, this is supplied with a glass surface 10, covering the table.

This will make the cleaning easier, in that the glass surface is suitable for achieveing high hygiene, due to the limited risk of bacteria growth.

The arms are made mainly from hollow aluminum tubes, profiles, but could of course be made from other materials, such as glass fiber.

In these hollow tubes all the necessary connections for the bracket table will be carried concealed from the lower part to the instruments. This will ease both their functions and the protection of these, and ease the cleaning thanks to the smooth surfaces of the profiles.

With the help of this suspension of the bracket table, a programmed positioning of the table is possible, so that it can function in relation to the adjustments of the chair and thereby the presence of the patient in the chair during the treatment, and the patient's access to and from the chair.

Concurrently, it is ensured that the bracket table is positioned in such a way that it can be used for both left- and right hand dentistry.

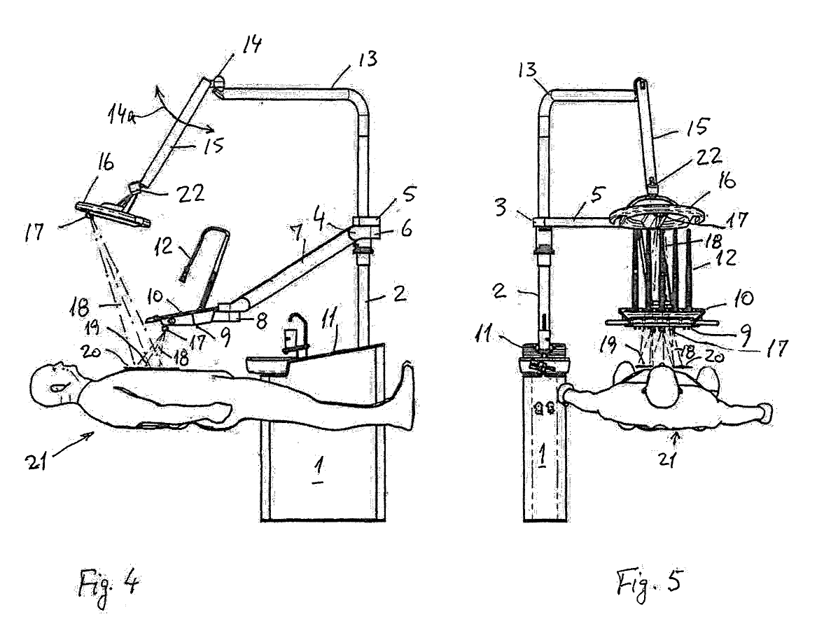

In FIG. 4 is shown a schematic depiction of a lower part 1 to which a turn/swing arm 7 is embedded. On this turn/swing arm the bracket table is mounted with instrumental couplings 12 for the included instruments of the treatment. Furthermore, a lamp 16 is mounted above the patient 21. The lamp is suspended in arms 15, 13, which are attached to the stand 2. The arms are connected in joints 14 and 22, so that the lamp 16 is mobile 14a and thereby can be adjusted into the desired position.

To the underside of the bracket table 9 and lamp 16 and/or the bracket table 9 is mounted one or more light transmitters 17, which can send light signals 18.

Each light transmitter 17 can transmit signals important to the treatment.

That could be water connection, air connection and its pressure, drilling speed and strain, meaning energy absorption, instrumental connection, patient data, such as pulse, blood pressure and other factors, which serve to monitor the instruments and the patient during the treatment.

In order to make these light signals 18 visible 19, and as closely to the patient's mouth as possible, signals 18 are, as shown in FIGS. 4 and 5, projected onto the chest of that of the shown example lying patient 21, when the bracket table 9 and/or the lamp 16 is positioned above the patient.

The signals 18 will be projected onto the patient in the form of color- or symbol markings 19, and when a napkin 20 is used, onto this.

The signal transmission can have various forms, in that they can be either in points or be of a larger scale.

Furthermore, the marking will be possible in various ways for easy identification of each signal transmission. That could entail a color shift or the intensity of the light, as an indicator of the drilling speed, strain, light and/or the blood pressure/pulse, just as auditive signal transmission can be given, if for example certain parameters are exceeded.

What is claimed is:

1. Dentist's unit comprising a console upon which one or more bracket tables and lamps are mounted to a lower part, wherein the bracket table/tables is revolvingly embedded to a bracket table arm, which bracket table arm is partly tiltably embedded to a bearing arm and partly revolvingly embedded to the bearing arm, which bearing arm is revolvingly embedded to a support, which is built into the lower part.

2. Dentist's unit according to claim 1, wherein to the table and/or the lamp is mounted one or more light transmitters for projection of light signals onto the patient.

3. Dentist's unit according to claim 1, wherein the signals, which hold indicators for the parameters, which are relevant to the dentist and to the treatment, are marked with the help of color or symbols onto e.g. a napkin placed on the patient's chest.

4. Dentist's unit according to claim 2, wherein the signals are supplied with one or more auditive signals.

5. Dentist unit according to claim 1, wherein the lamp is revolvingly embedded to an arm which is suspended to a support, which is fastened to the support.

6. Dentist's unit according to claim 1, wherein one or more of the suspensions are provided with built in actuators for the performance of the revolving/tilting movements, which actuators are controlled from a control unit for a predetermined setting of the position of the bracket table and/or the lamp.

7. Dentist's unit according to claim 1, wherein the bracket table and/or the lower part is provided with a glass-plate which makes up the surface.
